(19) United States
(12) Patent Application Publication
(10) Pub. No.: US 2024/0198550 A1
(43) Pub. Date: Jun. 20, 2024

(54) SHAVER HANDLE

(71) Applicant: BIC Violex Single Member S.A., Anoixi (GR)

(72) Inventors: Panagiotis KOPELAS, Anoixi (GR); Argyro KALLIVRETAKI, Anoixi (GR)

(73) Assignee: BIC Violex Single Member S.A., Anoixi (GR)

(21) Appl. No.: 18/540,614

(22) Filed: Dec. 14, 2023

(30) Foreign Application Priority Data
Dec. 15, 2022 (EP) 22213821.6

(51) Int. Cl. B26B 21/52

(52) U.S. Cl. CPC B26B 21/523; B26B 21/521; B26B 21/528

(57) ABSTRACT

In a first aspect, the present disclosure relates to a shaver handle comprising a first section and a second section translatable along a proximal-distal shaver handle axis relative to the first section, wherein the first section comprises a plurality of grooves and the second section comprises at least one protrusion, wherein each of the plurality of grooves is configured to form a snap joint with the at least one protrusion, wherein the first section and second section are connected by a sleeve configured to transition between an extended and a collapsed conformation.

### CROSS REFERENCE TO RELATED APPLICATIONS

This application claims benefit from European patent application EP 22213821.6 filed on Dec. 15, 2022, its content being incorporated herein by reference.

### TECHNICAL FIELD

The present disclosure relates to the field of shaver handles. More specifically, the present disclosure relates to shaver handles with adjustable length.

### BACKGROUND

Razors are well known everyday items to shave of unwanted bodily hair, e.g. beard hairs. The razor may comprise a razor cartridge including blades configured to cut the hair and a shaver handle used attached thereto. In use, a user holds the shaver handle and brings the razor cartridge into contact with a portion of skin. By movement of the shaver handle the razor cartridge moves in a shaving direction and unwanted hair is removed.

Many users shave daily to remove unwanted hair. However, when travelling the shaver handle of the razor may take up a needlessly large amount of space. In particular, when a user travels light, e.g. for an overnight trip, they may only carry around a small piece of luggage. Additionally, some companies, such as a airlines, may provide their customers with small toiletries bags. However, these toiletry bags may only be able to hold shaver handles of small lengths, which may be unergonomic for the user.

The present disclosure aims to address the aforementioned issues in shaver handles.

### SUMMARY

In a first aspect, the present disclosure relates to a shaver handle comprising a first section and a second section translatable along a proximal-distal shaver handle axis relative to the first section. The first section comprises a plurality of grooves and the second section comprises at least one protrusion, wherein each of the plurality of grooves is configured to form a snap joint with the at least one protrusion. The first section and second section are connected by a sleeve configured to transition between an extended and a collapsed conformation.

In some embodiments, each of the plurality of grooves may be configured to form an annular or discontinuous annular snap joint with the at least one protrusion.

In some embodiments, the sleeve may comprise an elastic material, more specifically an elastomer and in particular an elastomeric silicone.

In some embodiments, the first section and the sleeve and/or the second section and the sleeve may be integrally formed.

In some embodiments, the second section may be at least partly disposed within the first section, more specifically the second section may comprise a first part and a second part, wherein the first part may be disposed within the first section.

In some embodiments, the second part of the second section and the first section may have the same outer diameter and the first part of the second section may have a smaller diameter than the second part.

In some embodiments, the plurality of grooves may be disposed on an inner side of the first section.

In some embodiments, the inner side of the first section may be tubular.

In some embodiments, the first section may comprise a first head end and the second section may comprise a second head end disposed opposite of the first head end along the proximal distal axis, more specifically the first head end may be disposed in distal direction of the second head end.

In some embodiments, the first section may comprise at first motion limiter configured to prevent translation of the second section along the proximal-distal shaver handle axis in distal direction beyond a distal limit position, in particular the first motion limiter may be a protrusion disposed on the inside of the first section.

In some embodiments, the first section may comprise a second motion limiter configured to prevent translation of the second section along the proximal-distal shaver handle axis in proximal direction beyond a proximal limit position, more specifically the second motion limiter may be a protrusion disposed on the inside of the first section, in particular the second motion limiter may be disposed in proximal direction of the first motion limiter.

In some embodiments, the first motion limiter may be configured to abut with the second section, in particular the at least one protrusion, when the second section is translated into the distal limit position.

In some embodiments, the second motion limiter may be configured to abut with the second section when the second section is translated into the proximal limit position, in particular the second motion limiter may be configured to abut with the at least one protrusion when the second section is translated into the proximal limit position.

In some embodiments, the first section or second section may comprise a razor connector configured to engage a razor cartridge, more specifically the first section may comprise the razor connector and in particular the first section may comprise the razor connector at its distal end.

In some embodiments, the sleeve may be configured to enclose the first part of the second section, in particular the sleeve may be tubular.

In some embodiments, the sleeve may be foldable, in particular the sleeve may be configured to fold when the second section is translated towards the proximal direction relative to the first section.

In some embodiments, the sleeve may be in a folded conformation when the second section is in the distal limit position and an unfolded conformation when the second section is in the proximal limit position.

In some embodiments, the sleeve may be configured to have a uniform outer diameter when the second section is in the distal limit position.

In some embodiments, the sleeve may be configured to have non-uniform outer diameter when the second section is in the proximal limit position.

In some embodiments, the outer diameter of the sleeve may be configured to be equal to or greater than the outer diameter of the first and/or second section when the second section is in the proximal limit position.

In some embodiments, the maximum outer diameter of the sleeve may be configured to be equal to the outer diameter of the first and/or second section when the second section is in the distal limit position and the minimum diameter of the sleeve may be configured to be smaller than the outer diameter of the first and/or second section when the second section is in the distal limit position.

In some embodiments, the maximum outer diameter of the sleeve may be configured to be greater than the outer diameter of the first and/or second section when the first section is in the distal limit position and the minimum diameter of the sleeve may be configured to be equal to the outer diameter of the first and/or second section when the first section is in the distal limit position.

In some embodiments, the sleeve may be a repeating structure comprising four repeating units, wherein a cross-section of the first and third repeating unit may extend longitudinally along the proximal-distal shaver handle axis, a cross-section of the second repeating unit may be a quarter-circle and a cross-section of the fourth repeating unit may extend perpendicular to the proximal-distal shaver handle axis.

In some embodiments, the sequence of the four repeating units in the repeating structure may be the first repeating unit connected to the second repeating unit, the second repeating unit connected to the third repeating unit and the third repeating unit connected to the fourth repeating unit.

In some embodiments, the first repeating unit and the third repeating unit may be disposed parallel one another, more specifically the outer diameter of the first repeating unit may be greater than the outer diameter of the third repeating unit.

In some embodiments, the second repeating unit may comprise a first unit end connected to the first repeating unit and a second unit end connected to the third repeating unit, wherein the first unit end may be disposed in distal direction of the second unit end when the second section is in the proximal limit position and wherein the first unit end may be disposed in proximal direction of the second unit end when the second section may be in the distal limit position.

In some embodiments, the shaver handle may be a one-piece part.

In some embodiments, the shaver handle may comprise a plurality of layers, in particular a plurality of layers substantially parallel to each other.

In some embodiments, a layer of the plurality of layers may have a thickness between about 5 μm to about 100 μm, more specifically between about 10 μm to about 50 μm and in particular between about 15 μm to about 30 μm.

In some embodiments, a layer of the plurality of layers may have a thickness between about 0.05 mm to about 0.6 mm, more specifically between about 0.1 μm to about 0.4 mm and in particular between about 0.15 mm to about 0.3 mm.

In some embodiments, the shaver handle may comprise a first polymer, more specifically a photopolymer and in particular an ABS-like polymer and/or polypropylene-like polymer.

In some embodiments, the first polymer may have a Shore D hardness between about 50 to about 120, more specifically between about 55 to about 100 and in particular between about 60 to about 90, measured according to ISO 868:2003. In some embodiments, the shaver handle may comprise a second polymer.

In some embodiments, the second polymer may have a shore A hardness between about 10 to about 95, more specifically between about 25 to about 80 and in particular between about 35 to about 60, measured according to ASTM D2400-15.

In some embodiments, the shaver handle may comprise a third polymer, more specifically a thermoplastic polymer and in particular ABS and/or polypropylene.

In some embodiments, the shaver handle may comprise a fourth polymer, more specifically a thermoplastic elastomer and in particular a TPA, a TPC, a TPO, a TPS, a TPV, a TPZ and/or a TPU.

In some embodiments, the first section and/or second section may comprise the first and/or second polymer.

In some embodiments, sleeve may comprise the second and/or fourth polymer.

In a second aspect, the present disclosure relates to a razor system comprising a shaver handle according to any preceding claim and a razor cartridge, wherein the razor cartridge is releasably attached to the shaver handle, in particular via a pivotable connection or a non-pivotable connection.

In a third aspect, the present disclosure relates to a method for manufacturing a shaver handle according to any preceding claim comprising: manufacturing the shaver handle using a computer-controlled manufacturing system, in particular additive manufacturing, even more particularly material jetting, fused filament fabrication, stereolithography and/or selective laser sintering.

In a fourth aspect, the present disclosure relates to a computer-based manufacturing system for manufacturing a shaver handle, comprising a control unit adapted to execute the method according to any preceding claim.

In a fifth aspect, the present disclosure relates to a computer program comprising computer readable code which cause a computer-based manufacturing system to carry out the method according to any preceding claim.

In a sixth aspect, the present disclosure relates to a computer readable medium comprising the computer readable code according to any preceding claim.

In a seventh aspect, the present disclosure relates to a model of the shaver handle according to any preceding claim for a computer-controlled manufacturing system, wherein the model may be configured to be processed by the computer-controlled manufacturing system to manufacture the shaver handle.

In an eighth aspect, the present disclosure relates to a computer-readable medium, wherein the computer-readable medium may comprise instructions configured to be processed by a computer-controlled manufacturing system to manufacture the shaver handle according to any preceding claim.

### DESCRIPTION OF THE DRAWINGS

FIG. 1 shows an isometric view of a shaver handle 10 according to the first aspect in two conformations.

FIG. 2 shows a cross-section of the shaver handle 10 according to the first aspect, wherein the second section 14 has been moved in distal direction relative to the first section 12.

FIG. 3 shows a cross-section of the shaver handle 10 of FIG. 2, wherein the second section 14 has been moved in proximal direction relative to the first section 12.

FIG. 4 shows an isometric view of a shaver handle 10 according to the first aspect comprising the sleeve 34.

FIG. 5 shows a cross-section of the shaver handle 10 of FIG. 4, wherein the second section 14 has been moved in distal direction relative to the first section 12.

FIG. 6 shows a cross-section of the shaver handle 10 of FIG. 5, wherein the second section 14 has been moved in proximal direction relative to the first section 12.

FIG. 7 shows a first motion limiter 28 abutting with a distal end of the first part 18 of the second section 14.

FIG. 8 shows a first motion limiter 28 abutting with a protrusion 22.

FIG. 9 is a close-up cross-sectional view of the sleeve 34 comprising four repeating units.

FIG. 10 is an isometric view of a shaver handle 10 according to the first aspect in two conformations, wherein the sleeve 34 has a greater maximum outer diameter than the first section 12 and the second section 14.

FIG. 11 shows a schematic drawing of a shaver handle 10 with the razor connector 100.

### DETAILED DESCRIPTION

Hereinafter, a detailed description will be given of the present disclosure. The terms or words used in the description and the aspects of the present disclosure are not to be construed limitedly as only having common-language or dictionary meanings and should, unless specifically defined otherwise in the following description, be interpreted as having their ordinary technical meaning as established in the relevant technical field. The detailed description will refer to specific embodiments to better illustrate the present disclosure, however, it should be understood that the presented disclosure is not limited to these specific embodiments.

In a first aspect, the present disclosure relates to a shaver handle 10 comprising a first section 12 and a second section 14 translatable along a proximal-distal shaver handle axis 20 relative to the first section 12. The first section 12 comprises a plurality of grooves 24 and the second section 14 comprises at least one protrusion 22, wherein each of the plurality of grooves 24 is configured to form a snap joint with the at least one protrusion 22. The first section and second section are connected by a sleeve configured to transition between an extended and a collapsed conformation.

The first section 12 and the second section 14 of the shaver handle 10 according to the first aspect may be translated along the proximal-distal shaver handle axis 20 relative to one another, to reduce the length of the shaver handle 10. By reducing the length, the shaver handle 10 may be more easily stowed away by the user in small pieces of luggage, e.g. in tiny toiletries bags.

Further, the plurality of grooves 24 in combination with the at least one protrusion 22 allow the user to adjust the length of the shaver handle 10. For example, the average length of a male hand is greater than the average length of a female hand. As a result, males may prefer a longer shaver handle 10 length and females may prefer a shorter shaver handle 10 length.

Further, in some embodiments, the shaver handle 10 may comprise a gripping portion. The gripping portion may be for example shaped to conform to the user's fingers or may comprise a high tack surface such as rubber to improve the handling of the shaver handle 10. By adjusting the length, the user may control the location of the gripping portion, which may improve the handling.

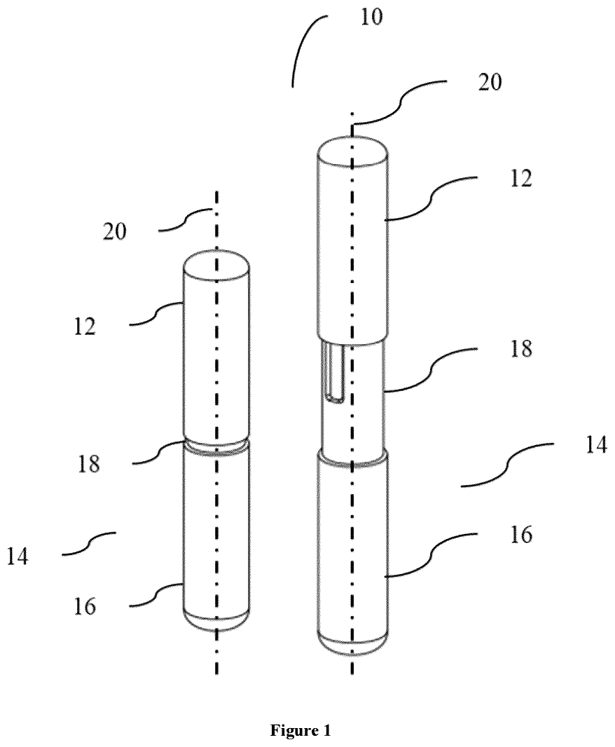

FIG. 1 shows an isometric view of a shaver handle 10 according to the first aspect in two conformations. The sleeve 34 is not depicted for overview purposes. The first section 12 is disposed in distal direction of the second section 14. On the left side the second section 14 has been translated in the distal direction relative to the first section 12 and the shaver handle 10 is therefore short. On the right side, the second section 14 has been translated in proximal direction relative to the first section 12 and the shaver handle 10 is therefore longer than the shaver handle depicted on the left side.

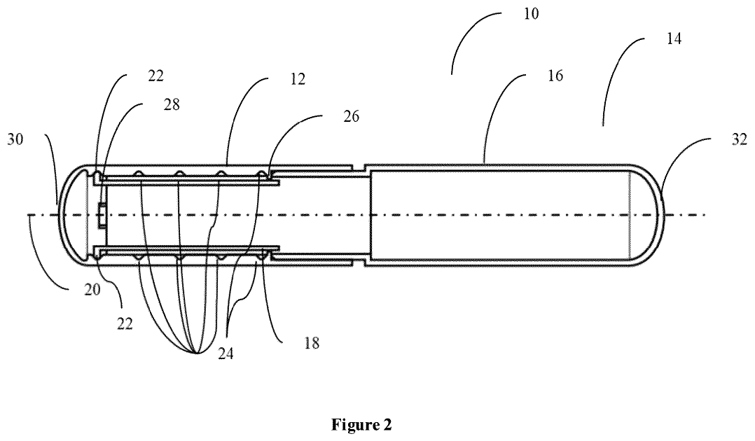

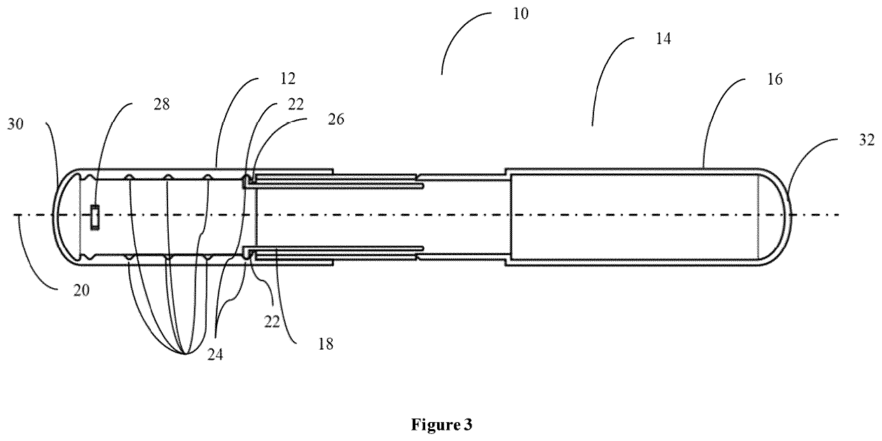

FIG. 2 shows a cross-section of the shaver handle 10 according to the first aspect, wherein the second section 14 has been moved in distal direction relative to the first section 12. The sleeve 34 is not depicted for overview purposes. The cross-section shows the plurality of grooves 24. The plurality of grooves 24 may be for example annular grooves. Accordingly, in some embodiments, each of the plurality of grooves 24 may be configured to form an annular or discontinuous annular snap joint with the at least one protrusion 22. Further, the cross-section shows two protrusions, which form a snap-joint with the most distal groove of the plurality of grooves 24. FIG. 3 shows a cross-section of the shaver handle 10 of FIG. 2, wherein the second section 14 has been moved in proximal direction relative to the first section 12. The cross-section shows that the two protrusions now form a snap-joint with the most proximal groove of the plurality of grooves 24.

As depicted in FIGS. 1, 2 and 3, in some embodiments, the second section 14 may be at least partly disposed within the first section 12, more specifically the second section 14 may comprise a first part and a second part, wherein the first part may be disposed within the first section 12.

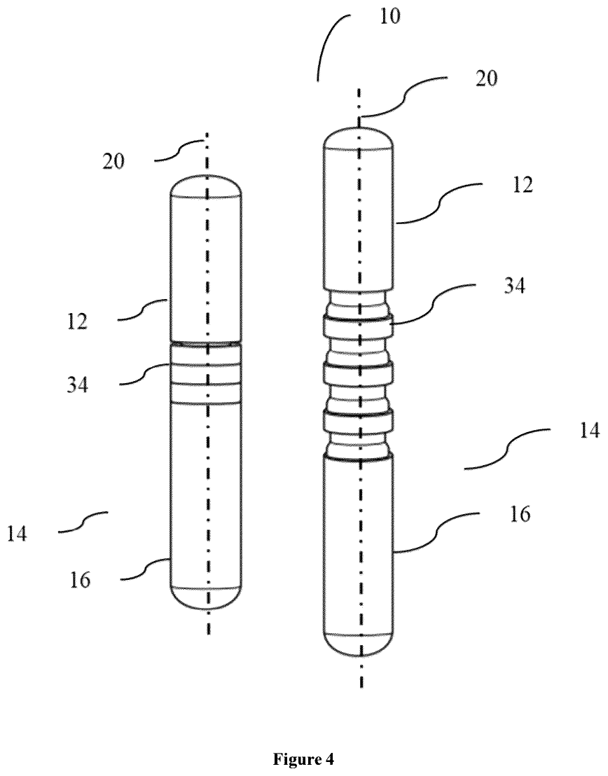

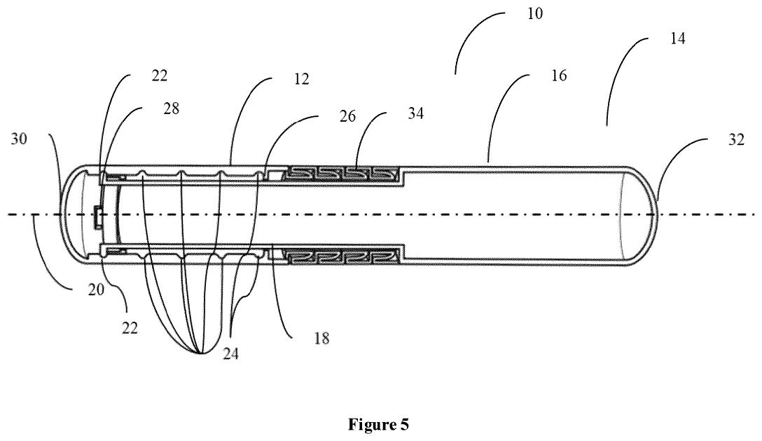

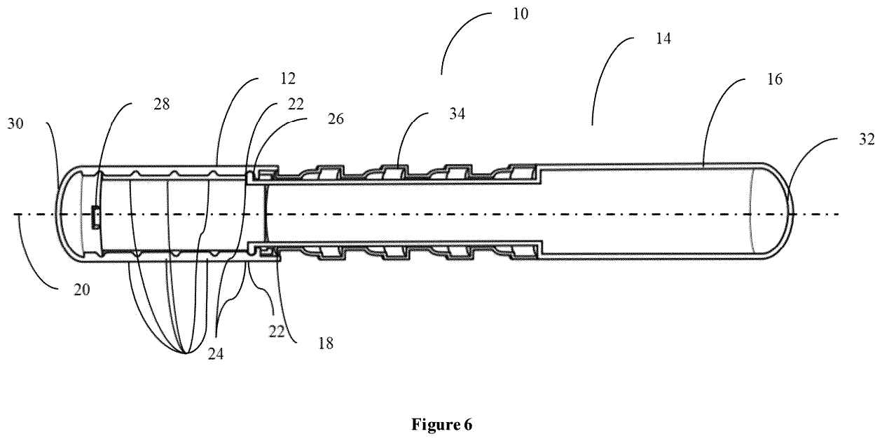

FIG. 4 shows an isometric view of a shaver handle 10 according to the first aspect comprising the sleeve 34. On the left side of FIG. 4 the sleeve 34 is in a collapsed conformation, in particular as the second section 14 has been translated in distal direction relative to the first section 12. On the right side of FIG. 4, the sleeve 34 is in an extended conformation, in particular as the second section 14 has been translated in proximal direction relative to the first section 12. The sleeve 34 may protect the shaver handle 10 from shaving debris to enter between moveable parts, more specifically between the first section 12 and the section, and in particular between the at least one protrusion 22 and the plurality of grooves 24. In some embodiments, the sleeve 34 may be configured to enclose the first part 18 of the second section 14. The sleeve 34 enclosing the first part 18 of the second section 14 may effectively prevent shaving debris from entering between moveable parts. FIG. 5 shows a cross-section of the shaver handle 10 depicted in FIG. 4, wherein the second section 14 has been moved in distal direction relative to the first section 12 and the sleeve 34 encloses the first part 18 of the second section 14, in particular a part of the first part 18 of the second section 14 which is not disposed in the first section 12. Correspondingly, FIG. 6 shows a cross-section of the shaver handle 10 of FIG. 5, wherein the second section 14 has been moved in proximal direction relative to the first section 12 and the encloses the first part 18 of the second section 14.

In some embodiments, the sleeve 34 may comprise an elastic material, more specifically an elastomer and in particular an elastomeric silicone. The elastic material may elongate to an extended conformation when the length of the shaver handle 10 is increased and contract to a collapsed conformation when the length of the shaver is reduced.

In some embodiments, the sleeve 34 may comprise a flexible material. The flexible material may be same as the elastic material. Further, the flexible material may be foldable, allowing to transition the sleeve 34 between an extended conformation and a collapsed conformation, wherein the flexible material is folded.

In some embodiments, the first section 12 and the sleeve 34 and/or the second section 14 and the sleeve 34 may be integrally formed. The first section 12 and the sleeve 34 and/or the second section 14 and the sleeve 34 being integrally formed may effectively prevent shaving debris from entering between moveable parts. The first section 12 and the sleeve 34 and/or the second section 14 and the sleeve 34 may be for example integrally formed by additive manufacturing.

In some embodiments, the first section 12 may comprise a first head end 30 and the second section 14 may comprise a second head end 32 disposed opposite of the first head end 30 along the proximal-distal shaver handle axis 20, more specifically the first head end 30 may be disposed in distal direction of the second head end 32. The proximal-distal shaver handle axis 20 may run centrally through the shaver handle 10.

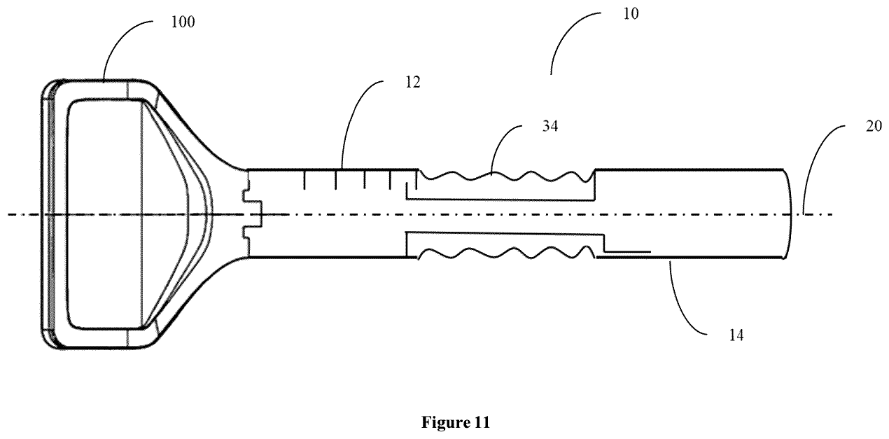

As depicted in FIG. 11, in some embodiments, the first section 12 or second section 14 may comprise a razor connector 100, more specifically the first section 12 may comprise the razor connector 100 and in particular the first section 12 may comprise the razor connector 100 at its distal end. In some embodiments, the razor connector 100 may be configured to engage a razor cartridge or may be integrally formed with a razor cartridge. In some embodiments, the first section 12 or second section 14 may be connected to other parts, e.g. a transition part, whereto the razor connector 100 is connected. In some embodiments, the first section 12 or second section 14 is integrally formed with a razor cartridge. FIG. 1 shows a schematic drawing of a shaver handle 10 with the razor connector 100.

In some embodiments, the first part 18 of the second section 14 may be preloaded. More specifically, the first part 18 of the second section 14 may be preloaded such that at least part of the first part, in particular the at least one protrusion 22, is configured to press against the inner side of the first section 12. The preloading may improve the formation of the snap-joint. For example, if the shaver handle 10 is manufactured by additive manufacturing, the at least one protrusion 22 may be manufactured within a selected groove of the plurality of grooves 34. As a result, when the at least one protrusion 22 is moved out of the groove in which it was manufactured, it presses against the inner side of the first section 12. Further, the selected groove may be deeper compared to the other grooves, such that the protrusion is also configured to press against the other grooves. The selected groove may be the most distal or most proximal groove of the plurality of grooves 34. Thus, a preload is created on the protrusion 22.

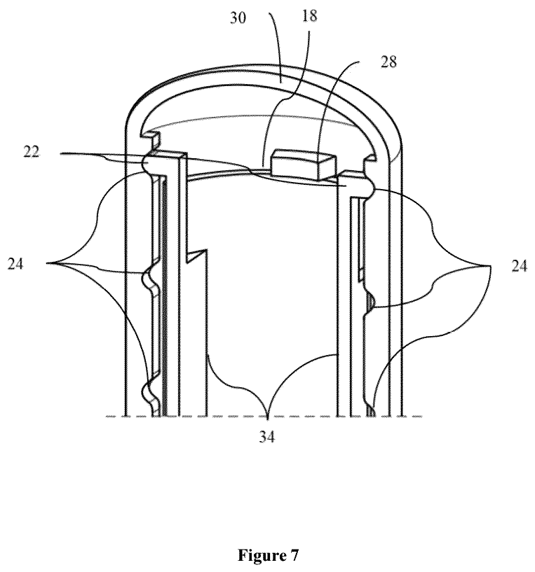

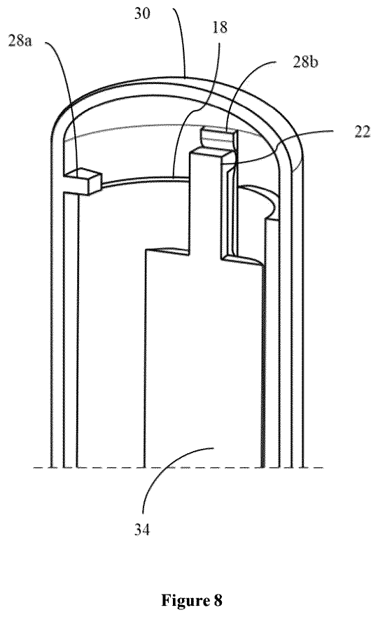

FIGS. 7 and 8 show provisions to prevent excessive movement of the second section 14 in distal direction relative to the first section 12. In particular, the second section 14 may not be moved along the proximal-distal shaver handle axis 20 beyond a distal limit position and a proximal limit position.

In some embodiments, the first section 12 may comprise a first motion limiter 28 configured to prevent translation of the second section 14 along the proximal-distal shaver handle axis 20 in distal direction beyond the distal limit position. In particular, as depicted in FIG. 7 and FIG. 8 the first motion limiter 28 may be a first limiter-protrusion disposed on the inside of the first section 12. In some embodiments, the first motion limiter 28 may be configured to abut with the second section 14, in particular the at least one protrusion 22, when the second section 14 is translated into the distal limit position, as shown in FIG. 8. Alternatively or additionally, in some embodiments, the second motion limiter 26 may be configured to abut with a distal end of the first part 18 of the second section 14 when the second section 14 is translated into the distal limit position, as depicted in FIG. 7.

Further, as is depicted in FIGS. 2, 3, 5 and 6, in some embodiments, the first section 12 may comprise a second motion limiter 26 configured to prevent translation of the second section 14 along the proximal-distal shaver handle axis 20 in proximal direction beyond the proximal limit position, more specifically the second motion limiter 26 may be a second limiter-protrusion disposed on the inside of the first section 12, in particular the second motion limiter 26 may be disposed in proximal direction of the first motion limiter 28. The first motion limiter 28 and the second motion limiter 26 may prevent damage to the shaver handle 10. For example, when the first section 12 is translated too far into the distal direction relative to the second section 14, in particular beyond the distal limit position, the first part 18 of the second section 14 may not be disposed within the first section 12 anymore and it may be difficult or impossible to reinsert into the first section 12. Further, the if the second section 14 is translated too far into the proximal direction relative to the second section 14, the sleeve 34 may be compressed, which may damage the material of the sleeve 34. Alternatively or additionally, if the second section 14 is translated too far into the proximal direction relative to the first section the at least one protrusion 22 may be damaged. In some embodiments, the second motion limiter 26 may be configured to abut with the second section 14 when the second section 14 is translated into the proximal limit position. In particular, in some embodiments the second motion limiter 26 may be configured to abut with the at least one protrusion 22 when the second section 14 is translated into the proximal limit position.

In the following the shape of the shaver handle 10 and arrangement of parts thereof is discussed.

In some embodiments, the second part 16 of the second section 14 and the first section 12 may have the same outer diameter and the first part 18 of the second section 14 may have a smaller diameter than the second part 16. As a result, as depicted in FIG. 1 and FIG. 4 the shaver handle 10 may exhibit a continuous diameter when in the collapsed conformation, in particular in case the sleeve's 34 outer diameter is the same as the outer diameter of the second part 16 of the second section 14 and the first section 12. The continuous diameter may prevent entanglement of other objects within the sleeve 34, for example when stored in a toiletries bag.

In some embodiments, the plurality of grooves may be disposed on an inner side of the first section 12. Accordingly, the at least one protrusion 22 may be disposed on an outer side of the second section 14, in particular on the outer side of the first part 18 of the second section 14. The inner side may be defined as the side of the first section 12 or second section 14 facing towards the proximal-distal shaver handle axis 20. The outer side may be defined as the side of the first section 12 or second section 14 facing away from the proximal-distal shaver handle axis 20.

In some embodiments, the inner side of the first section 12 may be tubular. Correspondingly, in some embodiments , the outer side of the first part 18 of the second section 14 may also be tubular. In some embodiments, the first part 18 of the second section 14 may also comprise or consist of at least one longitudinal strut, in particular at least two longitudinal struts, comprising the at least one protrusion 22, as depicted in FIG. 7 and FIG. 8. The longitudinal strut may extend parallel to the proximal-distal shaver handle axis 20 and may comprise the at least one protrusion 22 at its distal end.

In some embodiments, the outer side of the first section 12, the outer side of the second section 14 and the sleeve 34 may exhibit the same cross-sectional shape perpendicular to the proximal-distal shaver handle axis 20. In some embodiments, the sleeve 34 may be tubular. Accordingly, the cross-sectional shape of the outer side of the first section 12, the outer side of the second section 14 and the sleeve 34 may be circular, as depicted in the isometric views of FIG. 1 and FIG. 4. In some embodiments, the cross-sectional shape perpendicular to the proximal-distal shaver handle axis 20 of the outer side of the first section 12, the outer side of the second section 14 and the sleeve 34 may be trapezoidal, rectangular, square or oval. For non-circular cross-sectional shapes perpendicular to the proximal-distal shaver handle axis 20 the diameter of the cross-sectional shape may be the maximum diameter.

As mentioned above, in some embodiments, the sleeve 34 may be foldable, in particular the sleeve 34 may be configured to fold when the second section 14 is translated towards the proximal direction relative to the first section 12. In some embodiments, the sleeve 34 may be in a folded conformation when the second section 14 is in the distal limit position and an unfolded conformation when the second section 14 is in the proximal limit position. The folded and unfolded conformation may correspond to the collapsed and extended conformation. Accordingly, FIG. 4 on the left side and FIG. 5 show the sleeve 34 in a folded conformation, and FIG. 4 on the right side and FIG. 6 show the sleeve 34 in an extended conformation.

In some embodiments, as shown in FIG. 4, the sleeve 34 may be configured to have a uniform outer diameter when the second section 14 is in the distal limit position. As mentioned above, the uniform outer diameter, in particular if it is equal to the outer diameter of the first section 12 and the second part 16 of the second section 14, may prevent entanglement with other objects when the shaver handle 10 is stored. The term “equal” within this disclosure shall include a deviation of the diameters of up to 20%, more specifically up to 10% from one another. The term “uniform” outer diameter within this disclosure shall include gaps with a width of up to 2 mm, more specifically up to 1 mm. The width of the gaps shall be measured parallel to the proximal-distal shaver handle axis 20. In some embodiments, as also shown in FIG. 4, the sleeve 34 may be configured to have non-uniform outer diameter when the second section 14 is in the proximal limit position. The non-uniform outer diameter may provide a gripping portion for the user and may thereby improve the handling of the shaver handle 10.

In some embodiments, the outer diameter of the sleeve 34 may be configured to be equal to or greater than the outer diameter of the first 12 and/or second section 14 when the second section 14 is in the proximal limit position. In particular the outer diameter of the sleeve 34 may configured to be equal the outer diameter of the first and second section 14 when the second section 14 is in the proximal limit position, as is depicted in FIG. 4 on the left side. The thereby provided uniform outer diameter of the shaver handle may prevent entanglement with other objects when the shaver handle 10 is stored.

In some embodiments, the maximum outer diameter of the sleeve 34 may be configured to be equal to the outer diameter of the first 12 and/or second section 14 when the second section 14 is in the distal limit position and the minimum diameter of the sleeve 34 may be configured to be smaller than the outer diameter of the first 12 and/or second section 14 when the second section 14 is in the distal limit position, as is depicted in FIG. 4 on the right side. The aforementioned diameters may provide a gripping portion when the second section 14 is in the proximal limit position and a uniform diameter when the second section 14 is in the distal limit position.

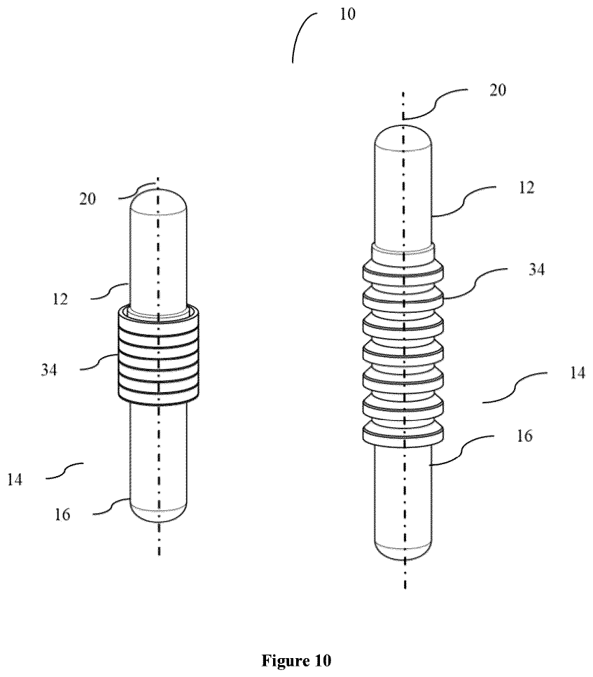

As depicted in FIG. 10, in some embodiments, the maximum outer diameter of the sleeve 34 may be configured to be greater than the outer diameter of the first 12 and/or second section 14 when the second section 14 is in the distal limit position and the minimum diameter of the sleeve 34 may be configured to be equal to the outer diameter of the first 12 and/or second section 14 when the second section 14 is in the distal limit position. The maximum outer diameter of the sleeve 34 being greater than the outer diameter of the first 12 and/or second section 14 may provide a shaver handle 10 of overall small dimensions, however, the sleeve 34 may act as a gripping portion of greater dimensions, which may improve the handling of the shaver handle 10.

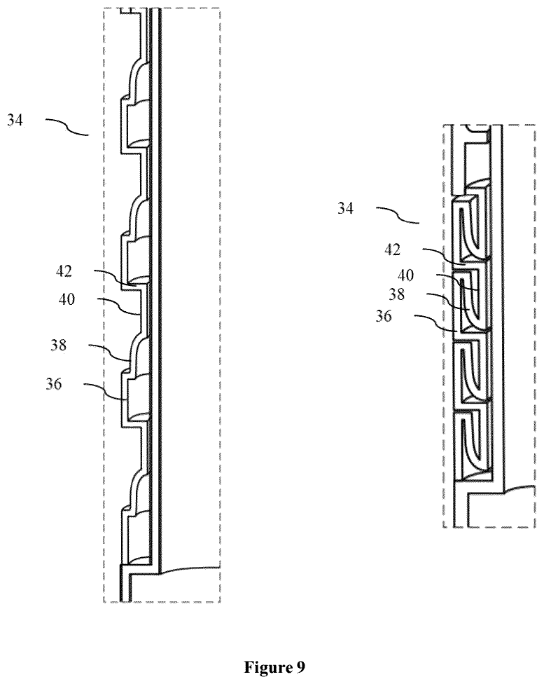

In some embodiments, the sleeve 34 may be a repeating structure comprising four repeating units. In some embodiments, a cross-section of the first and third repeating unit 40 may extend longitudinally along the proximal-distal shaver handle axis 20, a cross-section of the second repeating unit 38 may be a quarter-circle and a cross-section of the fourth repeating unit 42 may extend perpendicular to the proximal-distal shaver handle axis 20. FIG. 9 is a close-up cross-sectional view of the sleeve 34 comprising four repeating units. On the left side of FIG. 9 the sleeve 34 is in an unfolded or extended conformation and on the right side the sleeve 34 is in a folded or collapsed conformation. As depicted in FIG. 9, in some embodiments, the sequence of the four repeating units in the repeating structure may be the first repeating unit 36 connected to the second repeating unit 38, the second repeating unit 38 connected to the third repeating unit 40 and the third repeating unit 40 connected to the fourth repeating unit 42. In some embodiments, the first repeating unit 36 and the third repeating unit 40 may be disposed parallel one another, more specifically the outer diameter of the first repeating unit 36 may be greater than the outer diameter of the third repeating unit 40. The term “parallel” shall relate to the cross-sections first repeating unit 36 and third repeating unit 40 in the plane of the proximal-distal shaver handle axis 20 extending in the same direction. For example, the first repeating unit 36 and the second repeating unit 38 may exhibit the form of a first ring and second ring disposed around the proximal-distal shaver handle axis 20, wherein the diameter of the first ring is greater than that of the second ring and the cross-section of first ring and second ring extend longitudinally parallel to one another and to the proximal-distal shaver handle axis 20. In some embodiments, the second repeating unit 38 may comprise a first unit end connected to the first repeating unit 36 and a second unit end connected to the third repeating unit 40, wherein the first unit end may be disposed in distal direction of the second unit end when the second section 14 is in the proximal limit position and wherein the first unit end may be disposed in proximal direction of the second unit end when the second section 14 may be in the distal limit position. In some embodiments, a cross-section of the first, second, third and fourth repeating unit 42 perpendicular to the proximal-distal shaver handle axis 20 is circular. The aforementioned repeating structure may be readily extended and folded. Further, the repeating structure may provide a gripping portion for the user.

The four repeating units may form a repeating group. In some embodiments, the sleeve may comprise between 2 to about 10, more specifically 3 to about 6 of the repeating groups, in particular 5 repeating groups. The repeating groups may be arranged along the proximal-distal shaver handle axis 20.

In the following the material choices and manufacturing techniques for the shaver handle 10 are discussed.

In some embodiments, the shaver handle 10 may be a one-piece part. Integrally forming parts of the shaver handle 10 may decrease the assembly time of the shaver handle 10 drastically. In particular, manufacturing the shaver handle 10 as a one-piece part may lead to no assembly time for the shaver handle 10 at all. Manufacturing the handle as a one-piece part may be performed for example using additive manufacturing.

In some embodiments, the shaver handle 10 may comprise a plurality of layers, in particular a plurality of layers substantially parallel to each other. Additive manufacturing technologies, such as fused filament fabrication or material jetting may lead to a plurality of layers, in particular a plurality of layers substantially parallel to each other. In some embodiments, a layer of the plurality of layers may have a thickness between about 5 μm to about 100 μm, more specifically between about 10 μm to about 50 μm and in particular between about 15 μm to about 30 μm. In some embodiments, a layer of the plurality of layers may have a thickness between about 0.05 mm to about 0.6 mm, more specifically between about 0.1 μm to about 0.4 mm and in particular between about 0.15 mm to about 0.3 mm. The thickness of the plurality of layers may depend upon the process used for manufacturing. Further, a smaller layer thickness may lead to an increased manufacturing time of the shaver handle 10, but may also increase the mechanical stability and dimensional accuracy of the shaver handle 10.

In some embodiments, the shaver handle 10 may comprise a first polymer, more specifically a photopolymer and in particular an ABS-like polymer and/or polypropylene-like polymer. A photopolymer and in particular an ABS-like polymer and/or polypropylene-like polymer may be processable by an additive manufacturing process such as stereolithography. In some embodiments, the first polymer may have a Shore D hardness between about 50 to about 120, more specifically between about 55 to about 100 and in particular between about 60 to about 90, measured according to ISO 868:2003. The first polymer may be for example Durus or Rigur, by the company Stratasys, Ltd.

In some embodiments, the shaver handle 10 may comprise a second polymer. In some embodiments, the second polymer may have a shore A hardness between about 10 to about 95, more specifically between about 25 to about 80 and in particular between about 35 to about 60, measured according to ASTM D2400-15. The second polymer may be for example Tango or Agilus 30, by the company Stratasys, Ltd.

In some embodiments, the shaver handle 10 may comprise a third polymer, more specifically a thermoplastic polymer and in particular ABS and/or polypropylene. In some embodiments, the shaver handle 10 may comprise a fourth polymer, more specifically a thermoplastic elastomer and in particular a TPA, a TPC, a TPO, a TPS, a TPV, a TPZ and/or a TPU. Thermoplastic elastomers, as well as ABS and/or polypropylene may be processable by technologies wherein a solid material is liquified and subsequently resolidified for manufacturing, for example extrusion. Thermoplastic elastomers, as well as ABS and/or polypropylene may in particular be processable by additive manufacturing technologies such as fused filament fabrication and/or selective laser melting.

Additive manufacturing technologies may also be employed as multi-material processes, wherein a one-piece part comprising at least two different materials can be manufactured. For example, stereolithography and fused filament fabrication may be used to create multi-material parts. In fused filament fabrication the manufacturing device, e.g. the 3D-printer, may comprise multiple nozzles, wherein each nozzle is configured to extrude a different polymer. In stereolithography the part to be produced may change between vats comprising different precursors. Hence, additive manufacturing may be employed to optimize properties of certain parts and/or regions of the shaver handle 10 by varying the choice of material locally.

The second and/or fourth polymer may have a lower modulus of elasticity compared to the first and/or third polymer. A material with a lower modulus of elasticity exhibits a higher degree of deformation when exposed to the same force compared to a material with a higher modulus of elasticity. The second and/or fourth polymer may have a lower hardness, in particular shore A and/or shore D hardness, compared to the first and/or third polymer, which may allow for a higher degree of deformation of the second and/or fourth compared to the first and/or third polymer when exposed to the same force.

In some embodiments, the first section 12 and/or second section 14 may comprise the first and/or second polymer. The first and/or second polymer may provide the first section 12 and/or section with the required stiffness to withstand forces during the shaving action. In some embodiments, sleeve 34 may comprise the second and/or fourth polymer. The second and/or fourth polymer may provide the sleeve 34 with the required elasticity and/or flexibility to transition between the extended conformation and the collapsed conformation. Additionally, the second and/or fourth polymer may have a higher tack and/or coefficient of friction compared to the first and/or third polymer and may therefore provide better grip to the user.

In a second aspect, the present disclosure relates to a razor system comprising a shaver handle 10 according to any preceding claim and a razor cartridge, wherein the razor cartridge is releasably attached to the shaver handle 10, in particular via a pivotable connection or a non-pivotable connection.

In a third aspect, the present disclosure relates to a method for manufacturing a shaver handle 10 according to the first aspect. The method according to the second aspect comprises manufacturing the shaver handle 10 using a computer-controlled manufacturing system, in particular additive manufacturing, even more particularly material jetting, fused filament fabrication, stereolithography and/or selective laser sintering.

Further, the aspects relate to provisions for controlling additive manufacturing devices, as well as processing information related to manufacturing the razor handle 10.

In a fourth aspect, the present disclosure relates to a computer-based manufacturing system for manufacturing a shaver handle 10, comprising a control unit adapted to execute the method according to the second aspect.

The computer-based manufacturing system may comprise viewing interface (e.g., a monitor or screen), input devices (e.g., keyboard and/or mouse), and software for designing a computer-aided design (“CAD”) representation of a three-dimensional model. In at least some embodiments, the CAD representation can provide a model of the shaver handle 10. In some embodiments, computer-based manufacturing system may be in direct contact with one or more devices or systems of additive manufacturing device via network. The network may include any wired or wireless provisions that facilitate the exchange of information between computer-based manufacturing system and additive manufacturing device. In some embodiments, network may further include various components such as network interface controllers, repeaters, hubs, bridges, switches, routers, modems, and firewalls. In some cases, the network may be a wireless network that facilitates wireless communication between two or more systems, devices, and/or components of additive manufacturing device. Examples of wireless networks include, but are not limited to, wireless personal area networks (including, for example, Bluetooth), wireless local area networks (including networks utilizing the IEEE 802.11 WLAN standards), wireless mesh networks, mobile device networks as well as other kinds of wireless networks. In other cases, the network could be a wired network including networks whose signals are facilitated by twister pair wires, coaxial cables, and optical fibers. In still other cases, a combination of wired and wireless networks and/or connections could be used. A user may use a CAD system (e.g., CAD software) to design a customized path for a shaver handle 10. Embodiments may utilize any standard CAD or other software tool to design a particular model of the shaver handle 10.

Once a desired contoured path for the shaver handle 10 has been designed, a user may submit the shaver handle 10 design to the additive manufacturing device for manufacturing. In some cases, information related to the shaver handle 10 can be provided to additive manufacturing device in the form of a computer readable code, such as a 3D printing file format. In one embodiment, for example, the shaver handle 10 design and/or information associated with the shaver handle 10 design could be provided to the additive manufacturing device in an STL file format, which is a Stereolithography file format for 3D printing. In other embodiments, the information could be stored and/or transferred in the Additive Manufacturing File Format (AMF), which is an open standard for 3D printing information. Still other embodiments could store and/or transfer information using the X3D file format. In still other embodiments, any other file formats known for storing 3D objects and/or 3D printing information could be used.

In a fifth aspect, the present disclosure relates to a computer program comprising computer readable code which cause a computer-based manufacturing system to carry out the method according to the second aspect.

In a sixth aspect, the present disclosure relates to a computer readable medium comprising the computer readable code according to the fifth aspect.

In a seventh aspect, the present disclosure relates to a model of the shaver handle 10 according to the first aspect for a computer-controlled manufacturing system, wherein the model may be configured to be processed by the computer-controlled manufacturing system to manufacture the shaver handle 10.

In an eighth aspect, the present disclosure relates to a computer-readable medium, wherein the computer-readable medium may comprise instructions configured to be processed by a computer-controlled manufacturing system to manufacture the shaver handle 10 according to the first aspect.

Although the present disclosure is defined in the attached claims, it should be understood that the present disclosure can also (alternatively) be defined in accordance with the following embodiments:

1. A shaver handle (10) comprising a first section (12) and a second section (14) translatable along a proximal-distal shaver handle axis (20) relative to the first section (12), wherein the first section (12) comprises a plurality of grooves (24) and the second section (14) comprises at least one protrusion (22), wherein each of the plurality of grooves (24) is configured to form a snap joint with the at least one protrusion (22), wherein the first section (12) and second section (14) are connected by a sleeve (34) configured to transition between an extended and a collapsed conformation.

2. The shaver handle (10) according to embodiment 1, wherein each of the plurality of grooves (24) is configured to form an annular or discontinuous annular snap joint with the at least one protrusion (22).

3. The shaver handle (10) according to any preceding embodiment, wherein the sleeve (34) comprises an elastic material, more specifically an elastomer and in particular an elastomeric silicone.

4. The shaver handle (10) according to any preceding embodiment, wherein the first section (12) and the sleeve (34) and/or the second section (14) and the sleeve (34) are integrally formed.

5. The shaver handle (10) according to any preceding embodiment, wherein the second section (14) is at least partly disposed within the first section (12), more specifically wherein the second section (14) comprises a first part and a second part, wherein the first part is disposed within the first section (12).

6. The shaver handle (10) according to embodiment 5, wherein the second part (16) of the second section (14) and the first section (12) have the same outer diameter and wherein the first part (18) of the second section (14) has a smaller diameter than the second part.

7. The shaver handle (10) according to any one of embodiments 5 or 6, wherein the plurality of grooves is disposed on an inner side of the first section (12).

8. The shaver handle (10) according to embodiment 7, wherein the inner side of the first section (12) is tubular.

9. The shaver handle (10) according to any preceding embodiment, wherein the first section (12) comprises a first head end (30) and the second section (14) comprises a second head end (32) disposed opposite of the first head end (30) along the proximal-distal shaver handle axis (20), more specifically wherein the first head end (30) is disposed in distal direction of the second head end (32).

10. The shaver handle (10) according to any preceding embodiment, wherein the first section (12) comprises a first motion limiter (28) configured to prevent translation of the second section (14) along the proximal-distal shaver handle axis (20) in distal direction beyond a distal limit position, in particular wherein the first motion limiter (28) is a protrusion disposed on the inside of the first section (12).

11. The shaver handle (10) according to any preceding embodiment, wherein the first section (12) comprises a second motion limiter (26) configured to prevent translation of the second section (14) along the proximal-distal shaver handle axis (20) in proximal direction beyond a proximal limit position, more specifically wherein the second motion limiter (26) is a protrusion disposed on the inside of the first section (12), in particular wherein the second motion limiter (26) is disposed in proximal direction of the first motion limiter (28).

12. The shaver handle (10) according to embodiment 10 or 11, wherein the first motion limiter (28) is configured to abut with the second section (14), in particular the at least one protrusion (22), when the second section (14) is translated into the distal limit position.

13. The shaver handle (10) according to embodiment 11 or 12, wherein the second motion limiter (26) is configured to abut with the second section (14) when the second section (14) is translated into the proximal limit position, in particular wherein the second motion limiter (26) is configured to abut with the at least one protrusion (22) when the second section (14) is translated into the proximal limit position.

14. The shaver handle (10) according to any preceding embodiment, wherein the first section (12) or second section (14) comprises a razor connector (100), wherein the razor connector (100) is configured to engage a razor cartridge or wherein the razor connector (100) is integrally formed with a razor cartridge, more specifically wherein the first section (12) comprises the razor connector (100) and in particular wherein the first section (12) comprises the razor connector (100) at its distal end.

15. The shaver handle (10) according to any preceding embodiment, wherein the sleeve (34) is configured to enclose the first part (18) of the second section (14), in particular wherein the sleeve (34) is tubular.

16. The shaver handle (10) according to any preceding embodiment, wherein the sleeve (34) is foldable, in particular wherein the sleeve (34) is configured to fold when the second section (14) is translated towards the proximal direction relative to the first section (12).

17. The shaver handle (10) according to any preceding embodiment, wherein the sleeve (34) is in a folded conformation when the second section (14) is in the distal limit position and an unfolded conformation when the second section (14) is in the proximal limit position.

18. The shaver handle (10) according to any preceding embodiment, wherein the sleeve (34) is configured to have a uniform outer diameter when the second section (14) is in the distal limit position.

19. The shaver handle (10) according to any preceding embodiment, wherein the sleeve (34) is configured to have non-uniform outer diameter when the second section (14) is in the proximal limit position.

20. The shaver handle (10) according to any preceding embodiment, wherein the outer diameter of the sleeve (34) is configured to be equal to or greater than the outer diameter of the first (12) and/or second section (14) when the second section (14) is in the proximal limit position.

21. The shaver handle (10) according to any preceding embodiment, wherein the maximum outer diameter of the sleeve (34) is configured to be equal to the outer diameter of the first (12) and/or second section (14) when the second section (14) is in the distal limit position and wherein the minimum diameter of the sleeve (34) is configured to be smaller than the outer diameter of the first (12) and/or second section (14) when the second section (14) is in the distal limit position.

22. The shaver handle (10) according to any preceding embodiment, wherein the maximum outer diameter of the sleeve (34) is configured to be greater than the outer diameter of the first (12) and/or second section (14) when the first section (12) is in the distal limit position and wherein the minimum diameter of the sleeve (34) is configured to be equal to the outer diameter of the first (12) and/or second section (14) when the first section (12) is in the distal limit position.

23. The shaver handle (10) according to any preceding embodiment, wherein the sleeve (34) is a repeating structure comprising four repeating units, wherein a cross-section of the first and third repeating unit (40) extends longitudinally along the proximal-distal shaver handle axis (20), wherein a cross-section of the second repeating unit (38) is a quarter-circle and wherein a cross-section of the fourth repeating unit (42) extends perpendicular to the proximal-distal shaver handle axis (20).

24. The shaver handle (10) according to embodiment 23, wherein the sequence of the four repeating units in the repeating structure is the first repeating unit (36) connected to the second repeating unit (38), the second repeating unit (38) connected to the third repeating unit (40) and the third repeating unit (40) connected to the fourth repeating unit (42).

25. The shaver handle (10) according to embodiment 23 or 24, wherein the first repeating unit (36) and the third repeating unit (40) are disposed parallel one another, more specifically wherein the outer diameter of the first repeating unit (36) is greater than the outer diameter of the third repeating unit (40).

26. The shaver handle (10) according to any one of embodiments 23 to 25, wherein the second repeating unit (38) comprises a first unit end connected to the first repeating unit (36) and a second unit end connected to the third repeating unit (40), wherein the first unit end is disposed in distal direction of the second unit end when the second section (14) is in the proximal limit position and wherein the first unit end is disposed in proximal direction of the second unit end when the second section (14) is in the distal limit position.

27. The shaver handle (10) according to any preceding embodiment, wherein the shaver handle is a one-piece part.

28. The shaver handle (10) according to any preceding embodiment, wherein the shaver handle (10) comprises a plurality of layers, in particular a plurality of layers substantially parallel to each other.

29. The shaver handle (10) according to embodiment 28, wherein a layer of the plurality of layers has a thickness between about 5 μm to about 100 μm, more specifically between about 10 μm to about 50 μm and in particular between about 15 μm to about 30 μm.

30. The shaver handle (10) according to embodiment 28 or 29, wherein a layer of the plurality of layers has a thickness between about 0.05 mm to about 0.6 mm, more specifically between about 0.1 μm to about 0.4 mm and in particular between about 0.15 mm to about 0.3 mm.

31. The shaver handle (10) according to any preceding embodiment, wherein the shaver handle (10) comprises a first polymer, more specifically a photopolymer and in particular an ABS-like polymer and/or polypropylene-like polymer.

32. The shaver handle (10) according to embodiment 31, wherein the first polymer has a Shore D hardness between about 50 to about 120, more specifically between about 55 to about 100 and in particular between about 60 to about 90, measured according to ISO 868:2003.

33. The shaver handle (10) according to any preceding embodiment, wherein the shaver handle (10) comprises a second polymer.

34. The shaver handle (10) according to embodiment 33, wherein the second polymer has a shore A hardness between about 10 to about 95, more specifically between about 25 to about 80 and in particular between about 35 to about 60, measured according to ASTM D2400-15.

35. The shaver handle (10) according to any preceding embodiment, wherein the shaver handle (10) comprises a third polymer, more specifically a thermoplastic polymer and in particular ABS and/or polypropylene.

36. The shaver handle (10) according to any preceding embodiment, wherein the shaver handle (10) comprises a fourth polymer, more specifically a thermoplastic elastomer and in particular a TPA, a TPC, a TPO, a TPS, a TPV, a TPZ and/or a TPU.

37. The shaver handle (10) according to any one of embodiments 31 to 36, wherein the first section (12) and/or second section (14) comprise the first and/or second polymer.

38. The shaver handle (10) according to any one of embodiments 31 to 37, wherein sleeve (34) comprises the second and/or fourth polymer.

39. A razor system comprising a shaver handle (10) according to any preceding embodiment and a razor cartridge, wherein the razor cartridge is releasably attached to the shaver handle (10), in particular via a pivotable connection or a non-pivotable connection.

40. A method for manufacturing a shaver handle (10) according to any one of embodiments 1 to 38 comprising: manufacturing the shaver handle (10) using a computer-controlled manufacturing system, in particular additive manufacturing, even more particularly material jetting, fused filament fabrication, stereolithography and/or selective laser sintering.

41. A computer-based manufacturing system for manufacturing a shaver handle (10) according to any one of embodiments 1 to 38, comprising a control unit adapted to execute the method according to embodiment 40.

42. A computer program comprising computer readable code which cause a computer-based manufacturing system to carry out the method according to embodiment 40.

43. A computer readable medium comprising the computer readable code according to embodiment 42.

44. A model of the shaver handle (10) according to any one of embodiments 1 to 38 for a computer-controlled manufacturing system, wherein the model is configured to be processed by the computer-controlled manufacturing system to manufacture the shaver handle (10).

45. A computer-readable medium, wherein the computer-readable medium comprises instructions configured to be processed by a computer-controlled manufacturing system to manufacture the shaver handle (10) according to any one of embodiments 1 to 38.

1. A shaver handle comprising a first section and a second section translatable along a proximal-distal shaver handle axis relative to the first section, wherein the first section comprises a plurality of grooves and the second section comprises at least one protrusion, wherein each of the plurality of grooves is configured to form a snap joint with the at least one protrusion, wherein the first section and second section are connected by a sleeve configured to transition between an extended and a collapsed conformation.

2. The shaver handle according to claim 1, wherein each of the plurality of grooves is configured to form an annular or discontinuous annular snap joint with the at least one protrusion.

3. The shaver handle according to claim 1, wherein the sleeve comprises an elastic material, more specifically an elastomer and in particular an elastomeric silicone.

4. The shaver handle according to claim 1, wherein the first section and the sleeve and/or the second section and the sleeve are integrally formed.

5. The shaver handle according to claim 1, wherein the second section is at least partly disposed within the first section, more specifically wherein the second section comprises a first part and a second part, wherein the first part is disposed within the first section , in particular, wherein the second part of the second section and the first section have the same outer diameter and wherein the first part of the second section has a smaller diameter than the second part.

6. The shaver handle according to claim 1, wherein the plurality of grooves is disposed on an inner side of the first section.

7. The shaver handle according to claim 1, wherein the first section comprises a first motion limiter configured to prevent translation of the second section along the proximal-distal shaver handle axis in distal direction beyond a distal limit position, in particular wherein the first motion limiter is a protrusion disposed on the inside of the first section; and/or wherein the first section comprises a second motion limiter configured to prevent translation of the second section along the proximal-distal shaver handle axis in proximal direction beyond a proximal limit position, more specifically wherein the second motion limiter is a protrusion disposed on the inside of the first section, in particular wherein the second motion limiter is disposed in proximal direction of the first motion limiter.

8. The shaver handle according to claim 1, wherein the first section or second section comprises a razor connector, wherein the razor connector is configured to engage a razor cartridge or wherein the razor connector is integrally formed with a razor cartridge, more specifically wherein the first section comprises the razor connector and in particular wherein the first section comprises the razor connector at its distal end.

9. The shaver handle according to claim 7, wherein the first motion limiter is configured to abut with the second section, in particular the at least one protrusion, when the second section is translated into the distal limit position.

10. The shaver handle according to claim 7, wherein the second motion limiter is configured to abut with the second section when the second section is translated into the proximal limit position, in particular wherein the second motion limiter is configured to abut with the at least one protrusion when the second section is translated into the proximal limit position.

11. The shaver handle according to claim 1, wherein the sleeve is configured to enclose the first part of the second section, in particular wherein the sleeve is tubular.

12. The shaver handle according to claim 1, wherein the sleeve is foldable, in particular wherein the sleeve is configured to fold when the second section is translated towards the proximal direction relative to the first section, in particular wherein the sleeve is in a folded conformation when the second section is in the distal limit position and an unfolded conformation when the second section is in the proximal limit position.

13. The shaver handle according to claim 1, wherein the sleeve is configured to have a uniform outer diameter when the second section is in the distal limit position and/or wherein the sleeve is configured to have non-uniform outer diameter when the second section is in the proximal limit position.

14. The shaver handle according to claim 1, wherein the sleeve is a repeating structure comprising four repeating units, wherein a cross-section of the first and third repeating unit extends longitudinally along the proximal-distal shaver handle axis, wherein a cross-section of the second repeating unit is a quarter-circle and wherein a cross-section of the fourth repeating unit extends perpendicular to the proximal-distal shaver handle axis.

15. The shaver handle according claim 1, wherein the shaver handle comprises a plurality of layers, in particular a plurality of layers substantially parallel to each other.

16. The shaver handle according to claim 1, wherein the shaver handle is a one-piece part.

17. A model of the shaver handle according to claim 1 for a computer-controlled manufacturing system, wherein the model is configured to be processed by the computer-controlled manufacturing system to manufacture the shaver handle.

18. A computer-readable medium, wherein the computer-readable medium comprises instructions configured to be processed by a computer-controlled manufacturing system to manufacture the shaver handle according to claim 1.

19. A method for manufacturing the shaver handle according to claim 1 comprising:
manufacturing the shaver handle using a computer-controlled manufacturing system, in particular additive manufacturing, even more particularly material jetting, fused filament fabrication, stereolithography and/or selective laser sintering.

20. A computer-based manufacturing system for manufacturing the shaver handle of claim 1, comprising a control unit adapted to execute the method having the step:
manufacturing the shaver handle using the computer-controlled manufacturing system, in particular additive manufacturing, even more particularly material jetting, fused filament fabrication, stereolithography and/or selective laser sintering.
